(19) United States
(12) Patent Application Publication
(10) Pub. No.: US 2026/0318791 A1
(43) Pub. Date: Oct. 15, 2026

(54) RAPID SMEAR SLIDE DEVELOPMENT SYSTEM

(71) Applicant: BOARD OF REGENTS OF THE UNIVERSITY OF NEBRASKA, Lincoln, NE (US)

(72) Inventors: Thang Nguyen, Elkhorn, NE (US); Michael Wadman, Omaha, NE (US); Andrew Schnaubelt, Papillion, NE (US); Mara J Ana Broadhurst, Omaha, NE (US)

(21) Appl. No.: 19/481,131

(22) PCT Filed: Apr. 29, 2024
(86) PCT No.: PCT/US2024/026755

§ 371 Date: Nov. 3, 2025

Related U.S. Application Data
(60) Provisional application No. 63/463,123, filed on May 1, 2023.

(51) Int. Cl. G01N 1/28; G01N 1/31; G02B 21/34

(52) U.S. Cl. CPC G01N 1/2813; G01N 1/312; G02B 21/34; B01L 2200/025; B01L 2300/0822; B01L 2400/0406

(57) ABSTRACT

A rapid smear slide development system includes a base member including a slide dock formed by an indented portion of the base member. The base member is configured to hold a slide within the slide dock. The base member has a guide rail extending at least partially along at least one edge of the base member. The system further includes a wiper configured to glide along the guide rail, wherein the wiper is configured to actuate a scraper across a specimen on the slide so that the specimen is smeared across the slide.

### CROSS-REFERENCE TO RELATED APPLICATIONS

The present application is a U.S. National Phase of PCT Patent Application Number PCT/US 2024/026755 filed on Apr. 29, 2024, which claims priority under 35 U.S.C. § 119(e) to U.S. Provisional Application Ser. No. 63/463,123, filed May 1, 2023, and titled “Rapid Smear Slide Development System,” both of which are incorporated herein by reference in their entireties.

### TECHNICAL FIELD

The present disclosure generally relates to laboratory and field testing equipment and techniques, and more particularly to systems and methods for the development of smear slides.

### BACKGROUND

Smear slides are used in microscopy to detect or visualize microscopic organisms, debris, materials, or minerals. Smear slides are commonly used in medicine for the diagnosis of microbial infections from parasites, bacteria, or fungi as well as several diseases such as anemia, jaundice, sickle cell disease, thrombocytopenia, malaria, sudden kidney failure, G6PD deficiency, and certain cancers. There are many other applications of smear slides outside of medicine such as use in marine biology to examine marine sediments. One of the benefits of a smear slide is being able to use a relatively small biological sample, such as a few drops of blood, to perform the evaluation.

The development of a smear slide typically involves placing a small specimen droplet (e.g., a biological sample, such as blood) onto a microscopic glass side and using a scraper, such as a second glass slide, to smear the sample across the slide. This action spreads the sample in a uniformly thin layer across the glass slide. Development of a quality smear slide is skill-based and requires training and practice. Improper preparation of a smear slide can result in poor smear quality, limiting diagnostic potential. Currently, no commercial product exists to enable anyone to quickly and uniformly prepare a smear slide anywhere, for example, in a laboratory or out in the field.

### SUMMARY

Systems and methods for rapid smear slide development are disclosed herein. The disclosed systems and methods allow for quick and seamless development of smear slides through the use of guided scrapers or other guided tools to consistently produce high quality smear slides.

In an embodiment, a rapid smear slide development system includes a base member including a slide dock formed by an indented portion of the base member. The base member is configured to hold a slide within the slide dock. The base member has a guide rail extending at least partially along at least one edge of the base member. The system further includes a wiper configured to glide along the guide rail, wherein the wiper is configured to actuate a scraper across a specimen on the slide so that the specimen is smeared across the slide.

A method of preparing a thick smear slide with a rapid smear slide development system, such as the system described above, may include at least the following steps: placing a slide within a slide dock formed by an indented portion of a base member, wherein the slide dock includes a thick smear depth indicator; applying a specimen to the slide; and swirling the specimen around to smear the specimen across the slide until the thick smear depth indicator can be seen through the smeared specimen.

A method of preparing a thin smear slide with a rapid smear slide development system, such as the system described above, may include at least the following steps: placing a slide within a slide dock formed by an indented portion of a base member, wherein the base member includes a guide rail extending at least partially along at least one edge of the base member; applying a specimen to the slide; and actuating a scraper across the slide with a wiper that is configured to glide along the guide rail so that the specimen is smeared across the slide by the scraper.

In another embodiment, a rapid smear slide development system includes a housing including a sample reservoir, a slide frame, a guide rail, and a slide fixed within the slide frame. The sample reservoir is configured to receive a specimen and direct the specimen onto the slide through a channel that extends between the sample reservoir and the slide. The system further includes a wiper configured to glide along the guide rail, wherein the wiper is configured to actuate a scraper across the slide so that the specimen is smeared across the slide.

In another embodiment, a rapid smear slide development system includes a sample reservoir, a slide frame connected to the sample reservoir, and two slides fixed within the slide frame. The sample reservoir is configured to receive a specimen and direct the specimen in between the two slides through a channel that extends between the sample reservoir and the two slides, thereby causing the specimen to spread between the two slides to produce a smear pattern between the two slides as a result of capillary action.

In another embodiment, a rapid smear slide development system for simultaneously producing a thick smear slide and a thin smear slide includes a base member including a slide dock formed by an indented portion of the base member. The base member is configured to hold two overlapping slides offset by a thick smear stencil within the slide dock. The base member has a guide rail extending at least partially along at least one edge of the base member. The system further includes a wiper configured to glide along the guide rail, wherein the wiper is configured to actuate a scraper across a specimen on one of the two overlapping slides so that the specimen is smeared across the slide.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The Detailed Description is provided with reference to the accompanying Drawings. The use of the same reference numbers in different instances in the Detailed Description and the Drawings may indicate similar or identical items. The Drawings are not necessarily to scale, and any disclosed processes may be performed in an arbitrary order, unless a certain order of steps/operations is inherent or specified in the Detailed Description or in the Claims.

FIG. 1A is a perspective view of a rapid smear slide development system, in accordance with an example embodiment of this disclosure.

FIG. 1B is an exploded view of the rapid smear slide development system of FIG. 1A.

FIG. 1C is a top view of the rapid smear slide development system of FIG. 1A.

FIG. 1D is a bottom view of the rapid smear slide development system of FIG. 1A.

FIG. 1E is a side view of the rapid smear slide development system of FIG. 1A.

FIG. 1F is a first end view of the rapid smear slide development system of FIG. 1A.

FIG. 1G is a second end view of the rapid smear slide development system of FIG. 1A, opposite from the first end that is shown in FIG. 1F.

FIG. 2A is a partially exploded view of the rapid smear slide development system of FIG. 1A, further including one or more quick read (QR) codes on a smear slide and/or base member of the system, in accordance with an example embodiment of this disclosure.

FIG. 2B is a block diagram of an analyzer configured to detect the one or more QR codes and photograph and/or optically analyze the smear slide prepared by the rapid smear slide development system, in accordance with an example embodiment of this disclosure.

FIGS. 3A through 3H illustrate steps of a process for preparing a thick smear slide with the rapid smear slide development system of FIG. 1A, in accordance with an example embodiment of this disclosure.

FIGS. 4A through 40 illustrate steps of a process for preparing a thin smear slide with the rapid smear slide development system of FIG. 1A, in accordance with an example embodiment of this disclosure.

FIG. 5A is a perspective view of a rapid smear slide development system, wherein the system includes a sample reservoir configured to receive a specimen and direct the specimen onto a slide through a channel that fluidically connects the sample reservoir to the slide, in accordance with an example embodiment of this disclosure.

FIG. 5B is another perspective view of the rapid smear slide development system of FIG. 5A, wherein a sliding wiper is used to actuate a scraper across the specimen on the slide so that the specimen is smeared across the slide.

FIG. 5C is another perspective view of the rapid smear slide development system of FIG. 5A after the sliding wiper has returned to its original position and the specimen has been smeared across the slide.

FIG. 6A is an exploded view of a rapid smear slide development system, wherein the system includes a sample reservoir configured to receive a specimen and direct the specimen in between two slides through a channel that fluidically connects the sample reservoir to the space between the two slides, in accordance with an example embodiment of this disclosure.

FIG. 6B is a perspective view of the rapid smear slide development system of FIG. 6A.

FIG. 6C is a perspective view of the rapid smear slide development system of FIG. 6A after the specimen has spread between the two slides to produce a smear pattern between the two slides as a result of capillary action.

FIG. 7A is an exploded view of a rapid smear slide development system configured for simultaneously producing a thick smear slide and a thin smear slide using two overlapping slides offset by a thick smear stencil, in accordance with an example embodiment of this disclosure.

FIG. 7B is a perspective view of the rapid smear slide development system of FIG. 7A with specimen samples disposed on the thick smear (bottom) slide, within the thick smear stencil, and on the thin smear (top) slide.

FIG. 7C is a perspective view of the rapid smear slide development system of FIG. 7A, wherein a scraper is used produce a thick smear within the thick smear stencil on the thick smear (bottom) slide.

FIG. 7D is a perspective view of the rapid smear slide development system of FIG. 7A, wherein sliding wiper is used to actuate a scraper across the thin smear (top) slide to produce a thin smear.

### DETAILED DESCRIPTION

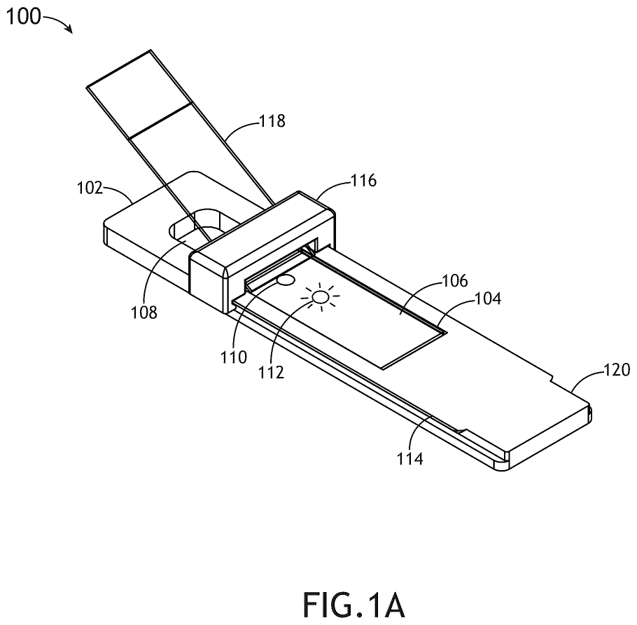

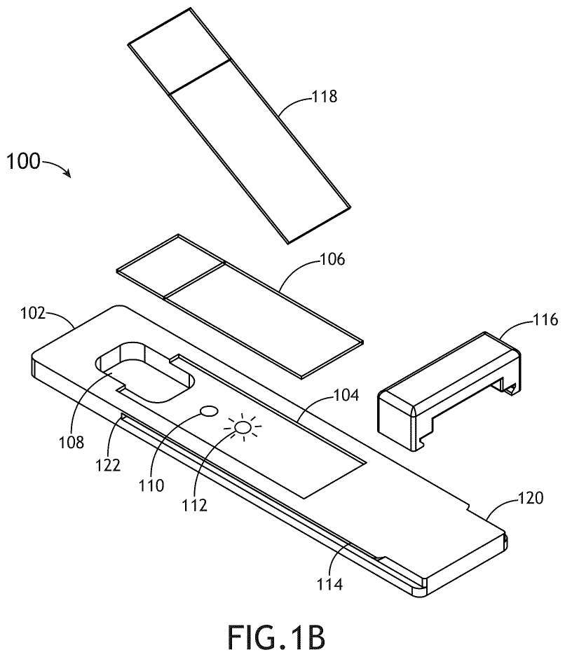

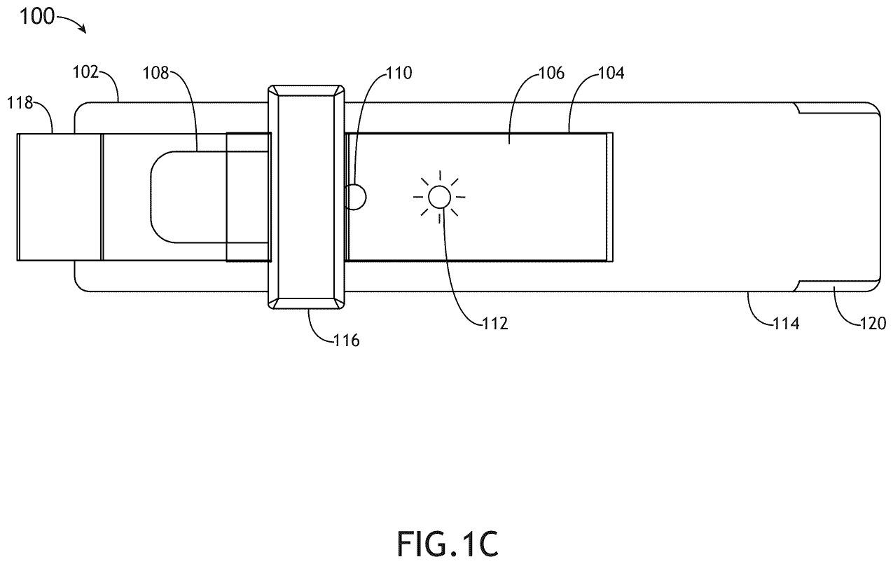

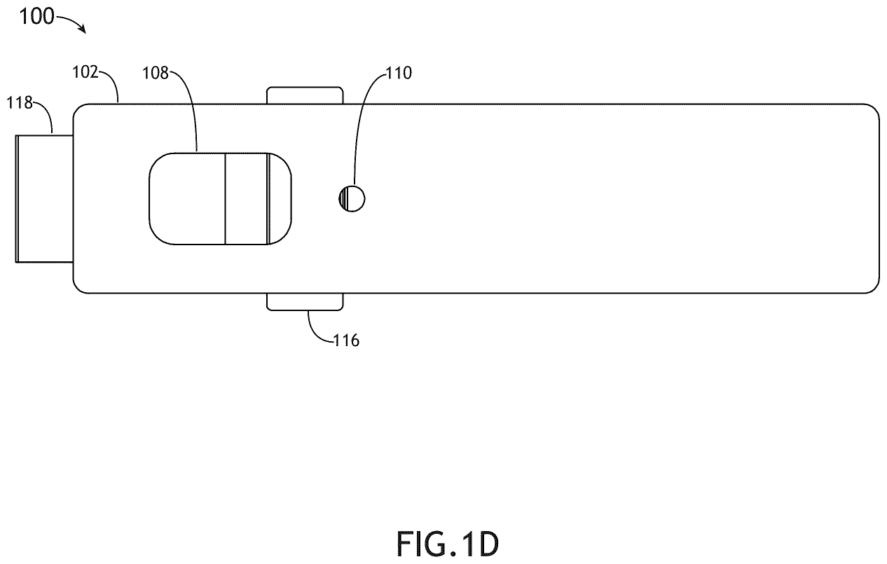

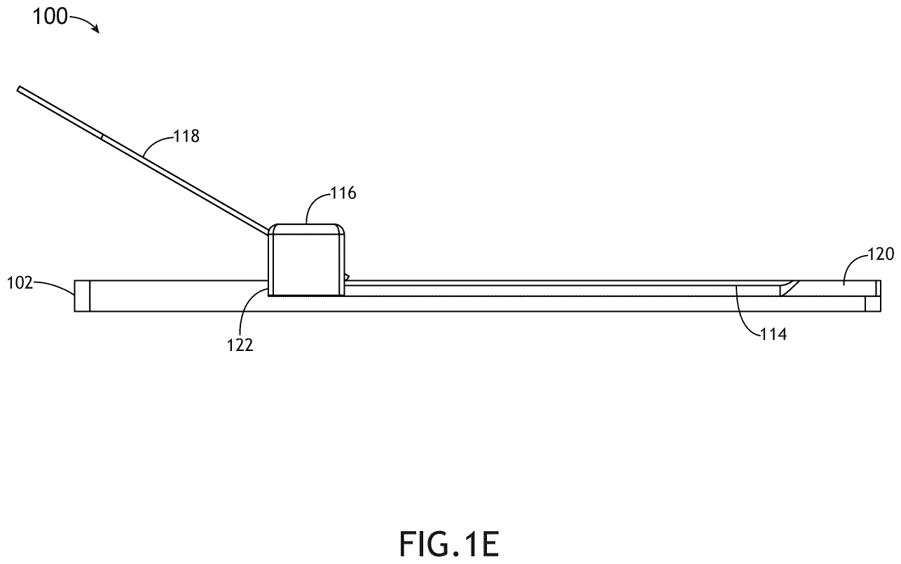

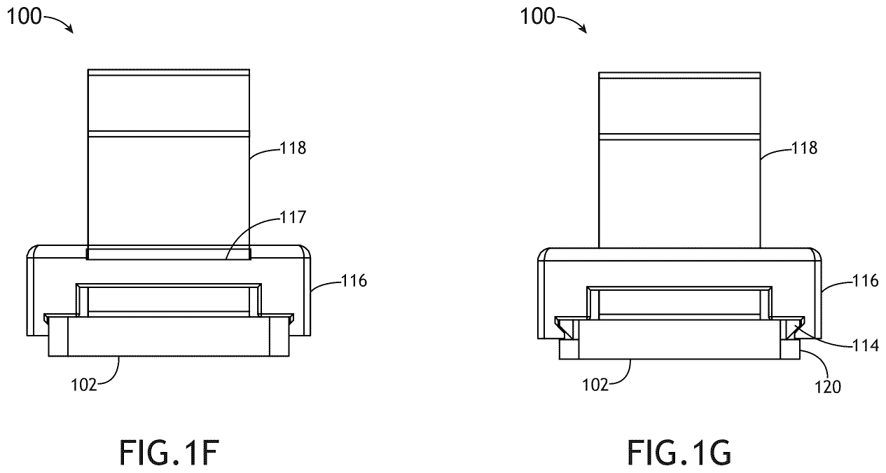

The present disclosure is directed to systems and methods that allow for quick and seamless development of smear slides through the use of guided scrapers or other guided tools to consistently produce high quality smear slides. Example embodiments of rapid smear slide development systems and associated methodology are discussed below with reference to FIGS. 1A through 7D. Those skilled in the art will appreciate that the embodiments illustrated in FIGS. 1A through 7D are specific examples that can be modified by changing dimensions or adding/removing non-essential components or fillers. Furthermore, two or more embodiments (or portions thereof) can be combined to achieve an additional embodiment that is not necessarily shown or described with reference to one drawing. As such, the drawings should not be construed as restrictive of any particular embodiment and are intended instead as visual aids to help describe configurations of certain components that may apply to multiple embodiments of a rapid smear slide development system.

FIGS. 1A through 1G illustrate a rapid smear slide development system 100, in accordance with an embodiment of the present disclosure. The rapid smear slide development system 100 can be used to produce smear slides from all types of fluid or semi-solid specimens, such as biological samples (e.g., blood, bone marrow, urine, saliva, etc.), environmental samples (e.g., water, sediment, wastewater, etc.), commercial fluid samples (e.g., pre-processed fluids, partially processed fluids, post-processed fluids, byproducts, etc.), and so forth, for the purpose of laboratory testing, field testing, data collection, or any other application.

As shown in FIGS. 1A and 1B, the system 100 includes a base member 102 including a slide dock 104 formed by an indented portion of the base member 102. The base member 102 may be constructed from any appropriate material, such as an injection molded plastic, 3D printed plastic, or the like. The base member 102 is configured to hold a slide 106 within the slide dock 104. In this regard, the slide dock 104 may be conformingly shaped, for example, with a width and/or length only slightly larger than that of a standard glass specimen slide.

In some embodiments, the depth of the slide dock 104 may also conform to the thickness of a standard glass specimen slide so that the slide 106 is flush with an upper surface of the base member 102 when the slide 106 is placed within the slide dock 104. This allows a scraper 118 to glide across the upper surface of the base member 102 and slide 106 at a set scraper height (e.g., as shown in FIG. 1E) without the need for additional height adjustment due to height disparity between the upper surface of the base member 102 and slide 106.

The slide 106 can be mounted firmly within the slide dock 104 because of the shape conformity described above. This helps prevent the slide 106 from wiggling around and causing inconsistent or low quality smears; however, this can also make it difficult to remove the slide 106 from the slide dock 104. To allow for easy removal of the slide 106, the slide dock 104 may include a cutout portion 108 that extends through the base member 102 to allow for dismounting the slide from the slide dock by reaching through the cutout portion. For example, in FIGS. 1C and 1D, the cutout 108 is shown to extend between the side dock 104 and an adjacent portion of the base member 108. This allows a user to insert their finger through a portion of the cutout 108 that is not covered by the slide 106 and reach around the slide 106 to grasp the edge of the slide 106 and remove it from the slide dock 104. However, in other embodiments, the cutout 108 is completely bounded by the side dock 104 and therefore fully covered by the slide 106; in which case, the user could extend their finger through the cutout 108 from beneath the slide 106 (i.e., from the lower surface of the base member 102 shown in FIG. 1D) to push the slide 106 out of the slide dock 104.

To assist a user in determining where to dispense or otherwise apply a specimen droplet and how large of a droplet to apply when preparing thin smear slides, the slide dock 104 may include a thin smear specimen location and size indicator 110. In some embodiments, the thin smear specimen location and size indicator 110 is a hole that extends all the way through the base member 102 as shown in FIGS. 1C and 1D, wherein the position and diameter of the hole respectively indicate the appropriate location and size of a specimen droplet for producing a thin smear slide. Using a hole for the thin smear specimen location and size indicator 110 is advantageous because the hole creates a high contrast marking that can be easily seen through the slide 106 when the slide 106 is mounted within the slide dock 104; however, in other embodiments, the thin smear specimen location and size indicator 110 may be printed, engraved, etched, applied as a sticker, placed within the slide dock 104 as an insert (e.g., on cardstock), or applied to the slide dock 104 by any other marking technique so that the thin smear specimen location and size indicator 110 is visible through the slide 106 when the slide 106 is mounted within the slide dock 104.

After the slide 106 is mounted within the slide dock 104 and a specimen has been applied to the slide 106, the rapid smear slide development system 100 is configured to produce a thin smear slide with a guided scraper 118. The base member 102 has a guide rail 114 extending at least partially along at least one edge of the base member 102. In preferred embodiments, the base member 102 has guide rails 114 along both of its long edges as can be seen in the end view of FIG. 1G. The system 100 includes a wiper 116 configured to glide along the guide rail(s) 114, wherein the wiper 116 is configured to actuate the scraper 118 across the slide 106 so that the specimen is smeared across the slide 106. The guide rail(s) 114 may be formed by long narrow indentations within the base member 102 and/or protrusions from the base member 102 that are cooperatively shaped to interface with gliding portions of the wiper 116. Alternatively, guide rail(s) 114 may be separately manufactured and attached (e.g., adhered or otherwise mounted) to the base member 102.

In some embodiments, the guide rail(s) 114 are preceded by a loading dock 120 at one end of the base member 102. As shown in FIG. 1B, the loading dock 120 may be a strip of the base member 102 without any guide rail(s) 114 (or at least no top rails) so that the wiper 116 can be dropped onto the loading dock 120 for proper alignment and then slid from the loading dock 120 onto the guide rail(s) 114.

The system 100 may further include a guide rail stop 122 at the other end of the base member 102. The guide rail stop 122 is a terminal portion of the guide rail(s) 114. The location of the guide rail stop 122 may correspond to the scraper 118 being slid by the wiper 116 to a position where the smearing edge of the scraper 118 has made optimal contact with the specimen on the slide 106. For example, the guide rail stop 122 and thin smear specimen location and size indicator 110 can be configured so that, when used properly, the specimen droplet is bisected in half by the scraper 118. This has been found to facilitate an appropriate amount of specimen for the smearing process.

The scraper 118 may be another specimen slide (e.g., like slide 106) or it can be any other type of glass/plastic sheet, a blade, or the like. In this regard, the scraper 118 is removably coupled to the wiper 116 and can be disposed of after use.

As shown in FIG. 1F, the wiper 116 may include a slot 117 configured to receive the scraper 118. The slot 117 may be slanted so that the wiper 116 holds the scraper 118 at an angle with respect to the upper surface of the base member 102. Hence, the scraper 118 is held at an angle with respect to the slide 106 when the slide 106 is held within the slide dock 104. For example, see FIG. 1A. In some embodiments, the slot 117 is configured to hold the scraper 118 at an angle in the range of 20 to 80 degrees, or preferably in the range of 30 to 60 degrees, with respect to the slide 106 although other ranges may be appropriate. For example, see FIG. 1E.

The scraper slot 117 within the wiper 116 may be conformingly shaped, for example, with a width and/or thickness only slightly larger than that of the scraper 118, thereby allowing the scraper 118 to fit tightly within the slot 117 so that it is held at a selected height by friction between the scraper 118 and the slot 117. In this regard, the scraper height is adjustable to accommodate specimen slides with different thicknesses or to produce smears with different thicknesses. In some embodiments, the slot 117 may have a tapered inlet or a guide to assist with loading the scraper 118 into the slot 117.

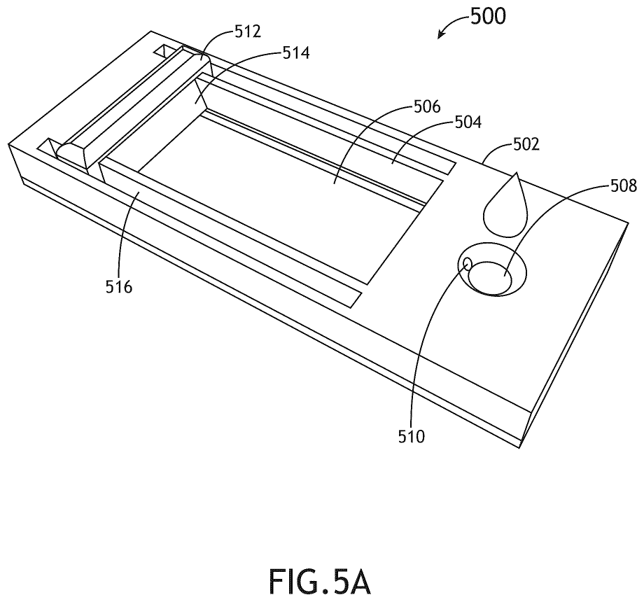

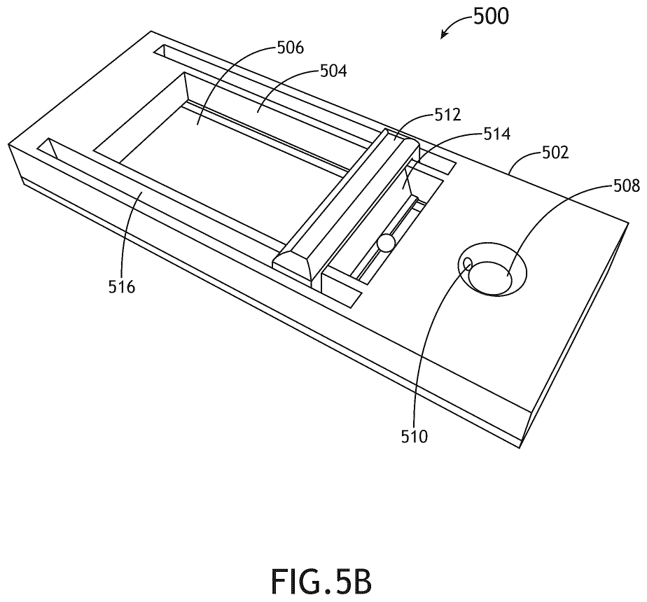

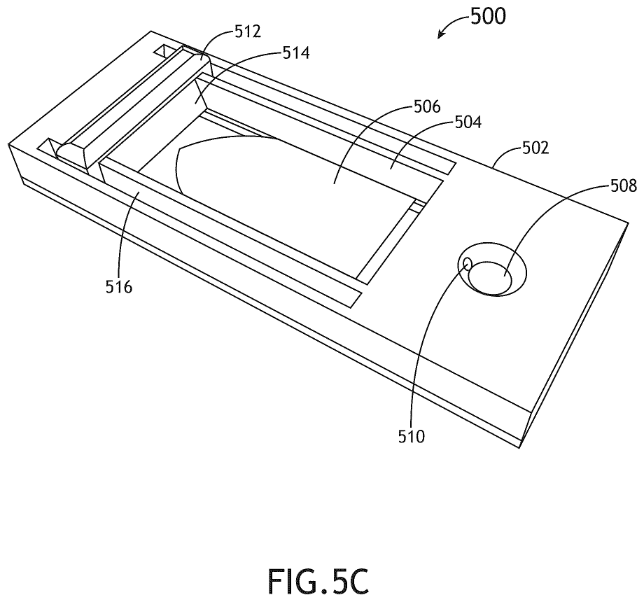

In other embodiments, the scraper 118 may be built into the wiper 116. For example, the scraper 118 can be a tapered edge/blade made from an injection molded or 3D printed portion of the wiper 116, or the scraper 118 can be a blade that is permanently attached to the wiper 116. For example, the scraper 118 and wiper 116 structures can be similar to those (scraper 514 and wiper 512) described with reference to FIGS. 5A through 5C. In embodiments with a scraper built into the wiper, the scraper may have a flexible edge (e.g., like a windshield wiper) thereby allowing a user to control the scraping pressure applied to a slide based on how hard they push down on the wiper.

The rapid smear slide development system 100 can be used to prepare thin smear slides by gliding the wiper 116 along the guide rail(s) 114 to actuate the scraper 118 across the slide 106 so that the specimen is smeared across the slide 106. The system 100 can also be used to prepare thick smear slides by manually spreading the specimen across the slide 106 with a handheld smearing tool (e.g., stir rod, toothpick, micro spatula, corner of another glass side, etc.). To accommodate this function, the slide dock 104 may include a thick smear depth indicator 112 (see FIG. 1C). In some embodiments, the thick smear depth indicator 112 comprises a high contrast (e.g., black on white) graphic that is visible through the slide 106. The thick smear depth indicator 112 is also visible through a smeared specimen when the specimen has been sufficiently spread out (thinly smeared enough) for the purposes of a thick smear slide. For example, FIG. 1C shows the thick smear depth indicator 112 as a symbolically drawn Sun that is printed within the slide dock 104, but in other embodiments, a different printed high contrast graphic may be used, or the high contrast graphic may be printed on a sticker or insert (e.g., a cardstock insert) that is placed within the slide dock 104. In other embodiments, the high contrast graphic is etched, engraved, or formed by small holes or slits that extend through the base member 102 (e.g., much like the thin smear specimen location and size indicator 110).

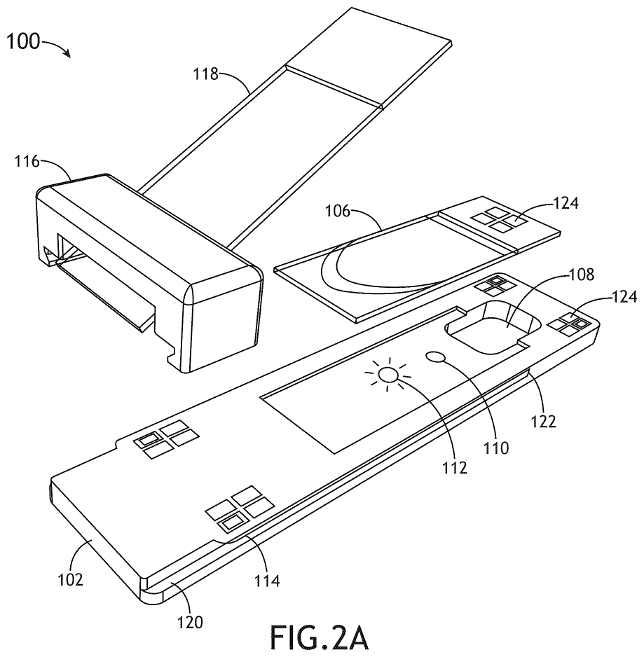

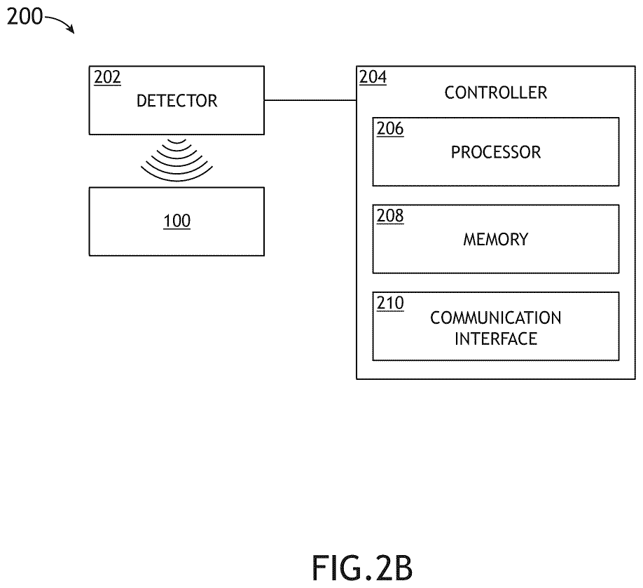

Referring now to FIG. 2A, the rapid smear slide development system 100 may further include one or more quick read (QR) codes 124 on the base member 102 and/or on each slide 106, wherein the QR code(s) 124 are detectable by an analyzer 200 (see FIG. 2B) that is configured to photograph and/or optically analyze the slide 106 after the specimen has been smeared across the slide 106. The QR code(s) 124 are configured to relay information to the analyzer 200, including specimen identifying information, specimen type, specimen preparation details, and/or microscopy details.

In embodiments, the analyzer 200 may be an automated slide preparation and examination system, but more generally, the analyzer 200 may include a smartphone, tablet, computer, and/or apparatus/system that includes the analyzer components illustrated in FIG. 2B. FIG. 2B is a block diagram of the analyzer 200, in accordance with an example embodiment of this disclosure. The analyzer 200 includes a detector 202 (e.g., a camera and/or optical sensor) that is communicatively coupled to a controller 204 configured to perform various image retrieval, image processing, machine learning, analysis, communication, and control functions of the analyzer 200 that are described herein. The controller 204 may include at least one processor 206, memory 208, and communication interface 210. As used herein, the term “controller” may include a microcontroller, programmable logic device (PLD), application specific integrated circuit (ASIC), personal computer (PC), embedded computer, industrial computer/controller, notebook computer, mobile device (e.g., smartphone, tablet, etc.), or the like.

The processor 206 provides processing functionality for the controller 204/analyzer 200 and can include any number of processors, microprocessors, microcontrollers, circuitry, field programmable gate array (FPGA) or other processing systems and resident or external memory for storing data, executable code and other information accessed or generated by the controller 204. The processor 206 can execute one or more software programs embodied in a non-transitory computer readable medium (e.g., memory) that implement techniques/operations described herein. The processor 206 is not limited by the materials from which it is formed, or the processing mechanisms employed therein and, as such, can be implemented via semiconductor(s) and/or transistors (e.g., using electronic integrated circuit (IC) components), and so forth.

The memory 208 may include any tangible, computer-readable storage medium that provides storage functionality to store various data and/or program code associated with operation of the controller 204/processor 206, such as software programs and/or code segments, or other data to instruct the processor 206, and possibly other components of the controller 204, to perform the functionality described herein. Thus, the memory 208 can store data, such as a program of instructions for operating the controller 204, including its components (e.g., processor 206, communication interface 210, etc.), and so forth. It should be noted that while a single memory is described, a wide variety of types and combinations of memory (e.g., tangible, non-transitory memory) can be employed. The memory 208 can be integrated within the processor 206, can comprise stand-alone memory, or can be a combination of both. Some examples of the memory 208 can include removable and non-removable memory components, such as random-access memory (RAM), read-only memory (ROM), flash memory (e.g., a secure digital (SD) memory card, a mini-SD memory card and/or a micro-SD memory card), solid-state drive (SSD) memory, magnetic memory, optical memory, universal serial bus (USB) memory devices, hard disk memory, external memory, or the like.

The communication interface 210 can be operatively configured to communicate with components of the controller 204. For example, the communication interface 210 can be configured to retrieve data from the processor 206 or other devices, transmit data for storage in the memory 208, retrieve data from storage in the memory 208, and so forth. The communication interface 210 can also be communicatively coupled with the processor 206 to facilitate data transfer between components of the controller 204 and the processor 206. It should be noted that while the communication interface 210 is described as a component of the controller 204, one or more components of the communication interface 210 can be implemented as external components communicatively coupled to the controller 204 via a wired and/or wireless connection. The controller 204 can also include and/or connect to one or more input/output (I/O) devices (e.g., detector 202, etc.) via the communication interface 210. In embodiments, the communication interface 210 may also include or may be coupled with a transmitter, receiver, transceiver, physical connection interface, or any combination thereof.

It is noted that the functions, steps or operations described herein are not necessarily all performed by one controller. Instead, the “controller 204” may comprise a plurality of interconnected controllers. For example, one or more operations and/or sub-operations may be performed by a first controller, additional operations and/or sub-operations may be performed by a second controller, and so forth. Furthermore, some of the operations and/or sub-operations may be performed in parallel and not necessarily in the order that they are disclosed herein.

In embodiments, the QR code(s) 124 are positioned so that the detector 202 can quickly detect the QR code(s) 124 as the rapid smear slide development system 100 is inserted into or interacts with the analyzer 200. Typically, the wiper 116 and scraper 118 will be removed before interfacing the system 100 (i.e., the base member 102 and docked smear slide 106) with the analyzer 200. The QR code(s) 124 are capable of relaying specimen specific information to the analyzer including, but not limited to: specimen type (e.g., blood, bone marrow, urine, saliva, whether the specimen is a thin smear or thick smear, etc.); specimen preparation details (e.g., stain/dye type, procedure, etc.)—this information informs the analyzer 200 on how to prepare/fix the specimen slide 106; microscopy details (e.g., microscopy light coloring and intensity, microscopy depth/height in relation to the specimen slide 106, microscopy magnification, etc.)—this information informs the analyzer 200 on microscopy settings to optimize microscopic examination of the specimen slide 106; and specimen identifying information (e.g., specimen origin, collection date, specimen donor name, date of birth, age, contact information, race/ethnicity, sex, geographic data, medical record number, etc.). The function and information stored in the QR code(s) 124 can be updated in real time and transmitted to an external electronic record system. In some embodiments, via an over-the-air (OTA) software update, the QR code(s) 124 can change any of the above parameters to optimize slide preparation and examination.

Although the QR code(s) 124 and analyzer 200 are discussed with regard to system 100, any of the rapid smear slide development systems described herein (e.g., system 500, system 600, and/or system 700) may include QR code(s) with similar functionality, wherein the QR code(s) are applied to a smear slide and/or portions of the system that support the smear slide.

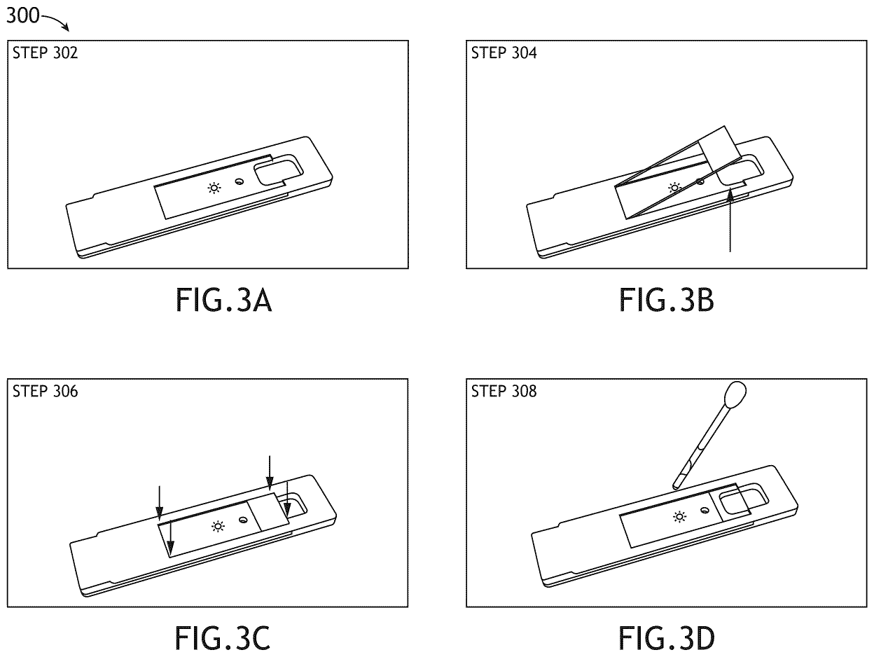

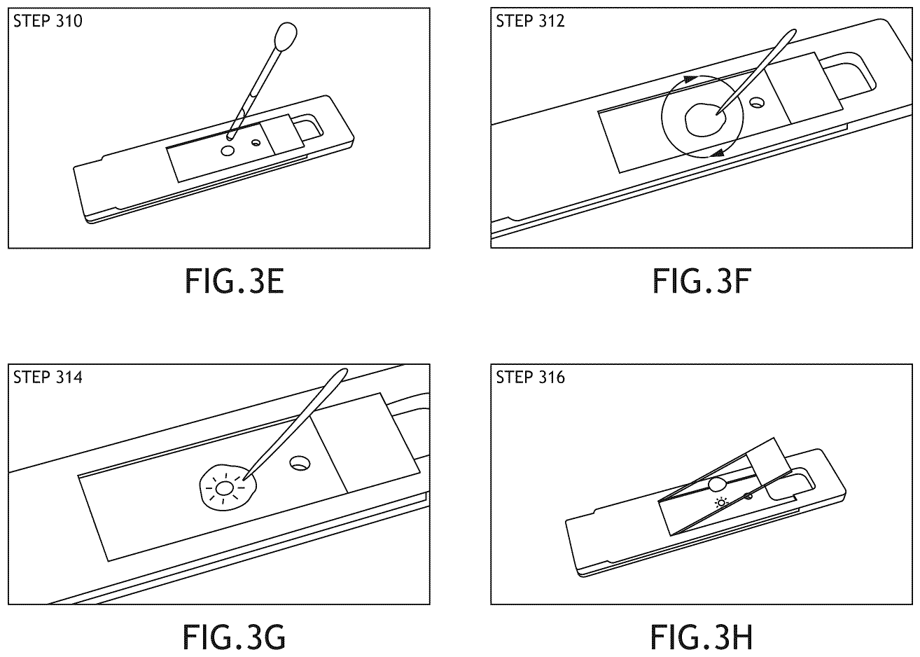

FIGS. 3A through 3H illustrate steps of a process 300 for preparing a thick smear slide with the rapid smear slide development system 100, in accordance with an example embodiment of this disclosure. In this regard, the process 300 may include any additional step that is implied by the system 100 as described above, and similarly, the system 100 may include any feature that is implied by the process 300 as described below. Numbering of the system 100 components below is with reference to FIGS. 1A through 1G.

FIG. 3A illustrates a step 302 placing the base member 102 on a flat and even surface.

FIG. 3B illustrates a step 304 of setting slide 106 (e.g., a pre-cleaned and labeled specimen glass slide) into the slide dock 104 of the base member 102, wherein a frosted or labeled end of the slide 106 is aligned with the cutout 108 portion of the slide dock 104 and/or base member 102.

FIG. 3C illustrates a step 306 of ensuring that the slide 106 is firmly seated within the slide dock 104 of the base member 102 by pressing down on all four corners of the slide 106.

FIG. 3D illustrates a step 308 of locating the thick smear depth indicator 112 (e.g., Sun symbol) that indicates where to apply a specimen droplet onto the slide 106 for thick smear preparation.

FIG. 3E illustrates a step 310 of placing a specimen droplet onto the slide 106 directly over the thick smear depth indicator 112.

FIG. 3F illustrates a step 312 of using a handheld smearing tool (e.g., stir rod, toothpick, micro spatula, corner of another glass side, etc.) to slowly spread out the specimen in a swirling motion until the thick smear depth indicator 112 can be seen through the specimen (step 314 in FIG. 3G).

FIG. 3H illustrates a final step 316 of removing the slide 106 from the slide dock 104 after the smeared specimen has dried, thereby completing the process of preparing a thick smear slide.

Although a detailed process 300 for preparing a thick smear slide with the system 100 is described above, a more generalized method of preparing a thick smear slide with a rapid smear slide development system, such as the system 100 described above, may include at least the following steps: (i) placing a slide 106 within a slide dock 104 formed by an indented portion of a base member 102, wherein the slide dock 104 includes a thick smear depth indicator 112; (ii) applying a specimen to the slide 106; and (iii) swirling the specimen around to smear the specimen across the slide 106 until the thick smear depth indicator 112 can be seen through the smeared specimen.

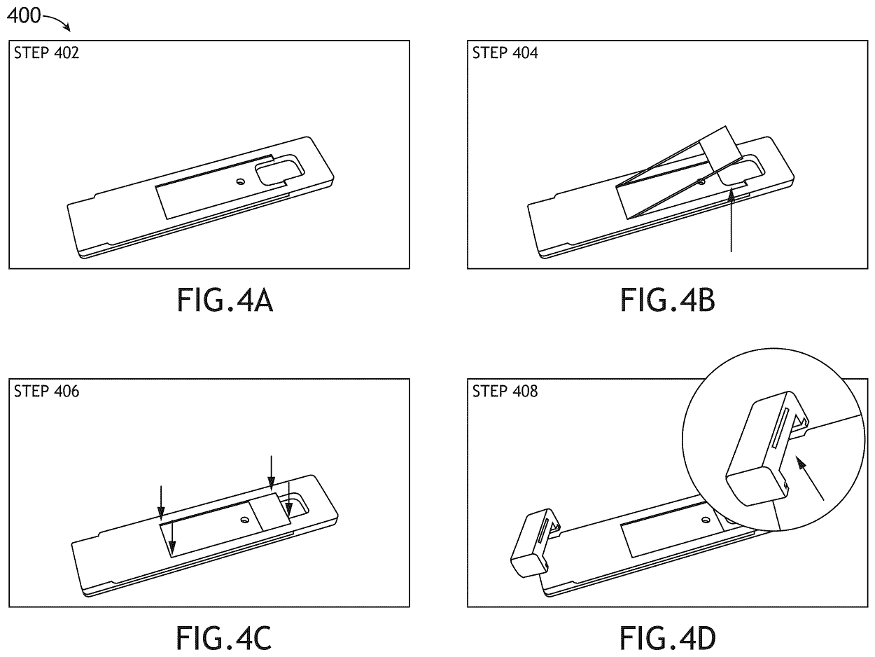

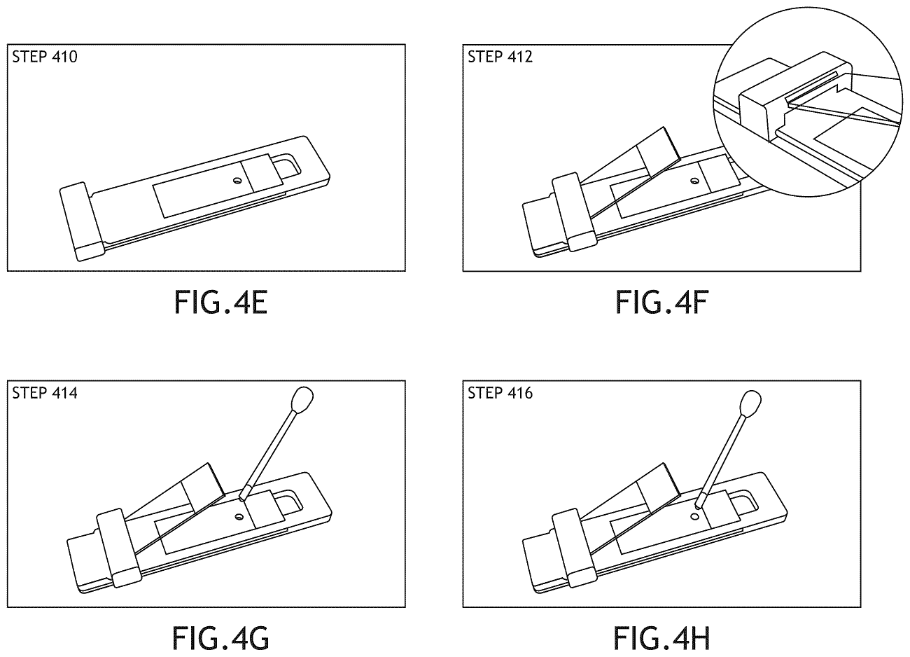

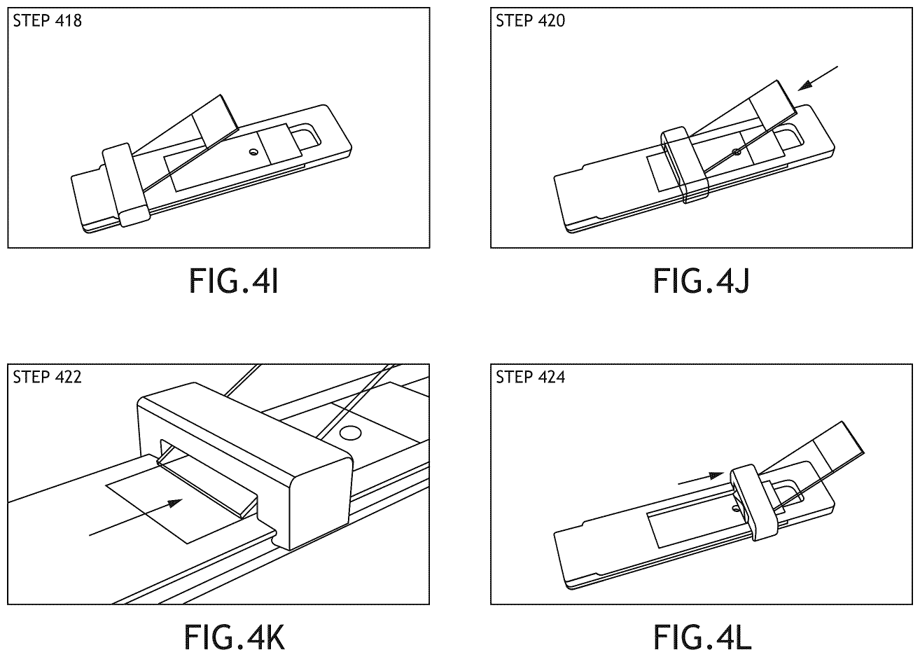

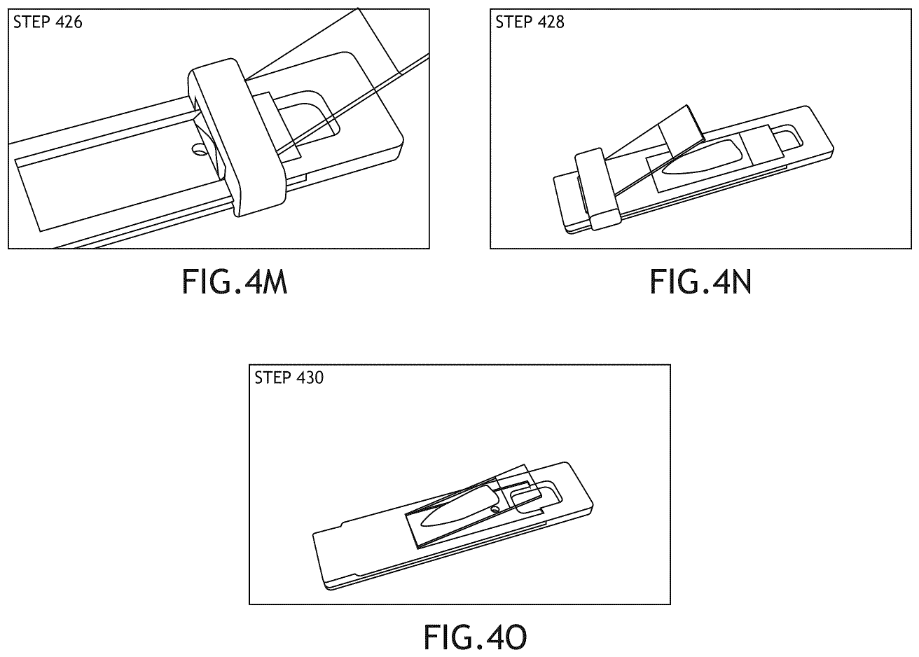

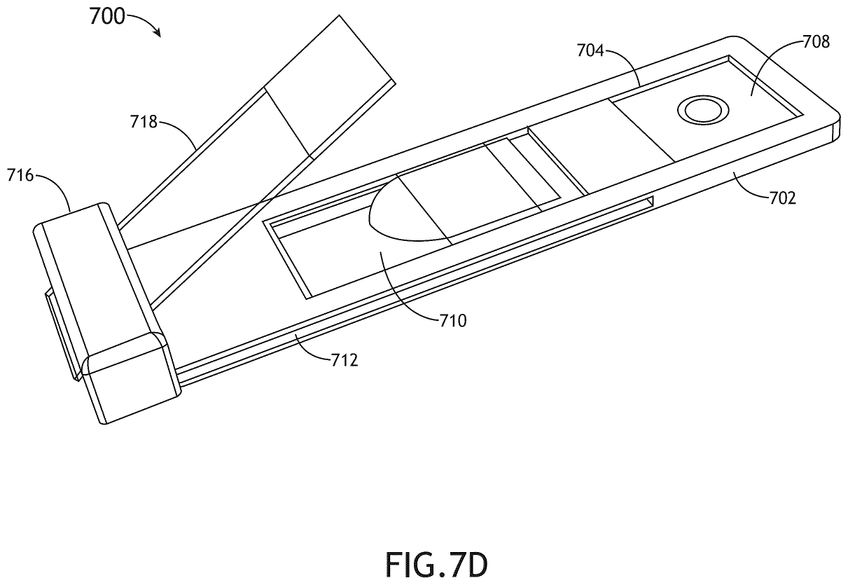

FIGS. 4A through 40 illustrate steps of a process 400 for preparing a thin smear slide with the rapid smear slide development system 100, in accordance with an example embodiment of this disclosure. In this regard, the process 400 may include any additional step that is implied by the system 100 as described above, and similarly, the system 100 may include any feature that is implied by the process 400 as described below. Numbering of the system 100 components below is with reference to FIGS. 1A through 1G.

FIG. 4A illustrates a step 402 placing the base member 102 on a flat and even surface.

FIG. 4B illustrates a step 404 of setting slide 106 (e.g., a pre-cleaned and labeled specimen glass slide) into the slide dock 404 of the base member 102, wherein a frosted or labeled end of the slide 106 is aligned with the cutout 108 portion of the slide dock 104 and/or base member 102.

FIG. 4C illustrates a step 406 of ensuring that the slide 106 is firmly seated within the slide dock 104 of the base member 102 by pressing down on all four corners of the slide 106.

FIG. 4D illustrates a step 408 of mounting the wiper 116 onto the loading dock 120 of the base member 102, wherein the slot 117 is facing toward the slide 106.

FIG. 4E illustrates a step 410 of sliding the wiper 116 toward the slide so that the wiper 116 engages the guide rail(s) 114 (as shown in FIG. 4F).

FIG. 4F illustrates a step 412 of sliding the scraper 118 (e.g., another glass slide) into the slot 117 of the wiper 116.

FIG. 4G illustrates a step 414 of locating the thin smear specimen location and size indicator 110 (e.g., circular hole) that indicates where to apply a specimen droplet onto the slide 106 and appropriate sizing of the specimen droplet for thin smear preparation.

FIG. 4H illustrates a step 416 of placing a specimen droplet onto the slide 106 directly over the thin smear specimen location and size indicator 110.

FIG. 4I illustrates a step 418 of securing the base member 102 with one hand while the wiper 116 is gripped with another hand.

FIG. 4J illustrates a step 420 of slowly moving the wiper 116 toward the slide 106 and gently pushing down on the scraper 118 until it makes contact with the slide 106.

FIG. 4K illustrates a step 422 of visually verifying that the scraper 118 is in contact with the surface of the slide 106.

FIG. 4L illustrates a step 424 of sliding the wiper 116 toward the specimen droplet until the wiper 116 reaches the guide rail stop 122.

FIG. 4M illustrates a step 426 visually confirming that the specimen has spread along the contact line between the scraper 118 and the slide 106.

FIG. 4N illustrates a step 428 of quickly pulling the wiper 116 away from the specimen droplet in a smooth motion to smear the specimen across the slide 106.

FIG. 4O illustrates a final step 430 of removing the slide 106 from the slide dock 104 after the smeared specimen has dried, thereby completing the process of preparing a thin smear slide.

Although a detailed process 400 for preparing a thin smear slide with the system 100 is described above, a more generalized method of preparing a thin smear slide with a rapid smear slide development system, such as the system 100 described above, may include at least the following steps: (i) placing a slide 106 within a slide dock 104 formed by an indented portion of a base member 102, wherein the base member 102 includes a guide rail 114 extending at least partially along at least one edge of the base member 102; (ii) applying a specimen to the slide 106; and (iii) actuating a scraper 118 across the slide with a wiper 116 that is configured to glide along the guide rail 114 so that the specimen is smeared across the slide 106 by the scraper 118.

FIGS. 5A through 5C illustrate a rapid smear slide development system 500, in accordance with another embodiment of the present disclosure. The rapid smear slide development system 500 can also be used to produce smear slides from all types of fluid or semi-solid specimens, such as biological samples (e.g., blood, bone marrow, urine, saliva, etc.), environmental samples (e.g., water, sediment, wastewater, etc.), commercial fluid samples (e.g., pre-processed fluids, partially processed fluids, post-processed fluids, byproducts, etc.), and so forth, for the purpose of laboratory testing, field testing, data collection, or any other application.

Referring now to FIG. 5A, the rapid smear slide development system 500 includes a housing 502 which may be constructed from any appropriate material, such as an injection molded plastic, 3D printed plastic, or the like. The housing 502 includes a sample reservoir 508, a slide frame 504, guide rail(s) 516 (preferably one on each edge as shown in FIG. 5A), and a slide 506 fixed within the slide frame 504. As shown in FIGS. 5A and 5B, the sample reservoir 508 is configured to receive a specimen and direct the specimen onto the slide 506 through a channel 510 that extends between the sample reservoir 508 and the slide 506. The system 500 further includes a wiper 512 configured to glide along the guide rail(s) 516, wherein the wiper 512 is configured to actuate a scraper 514 across the slide 506 so that the specimen is smeared across the slide 506. For example, see FIG. 5C.

Although the scraper 514 in FIGS. 5A through 5C is shown as being built into the wiper 512, the scraper 514 and wiper 512 structures can alternatively be similar to those (scraper 118 and wiper 116) described with reference to FIGS. 1A through 1G, and vice versa. In embodiments with a scraper built into the wiper, the scraper may have a flexible edge (e.g., like a windshield wiper) thereby allowing a user to control the scraping pressure applied to a slide based on how hard they push down on the wiper.

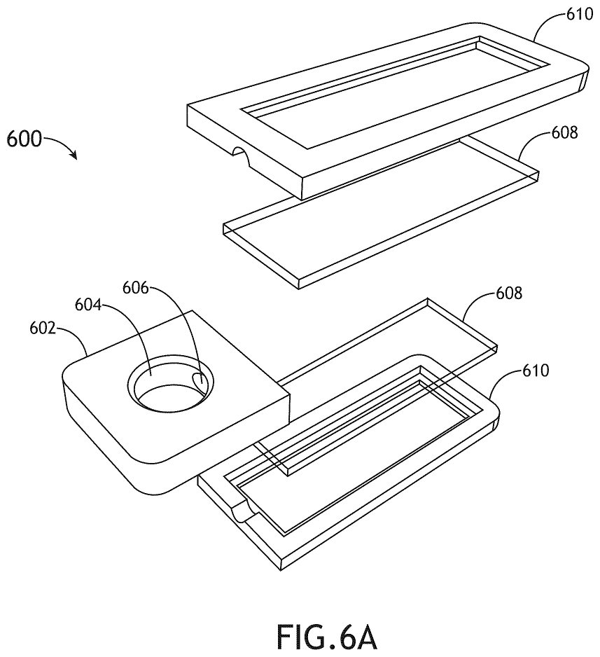

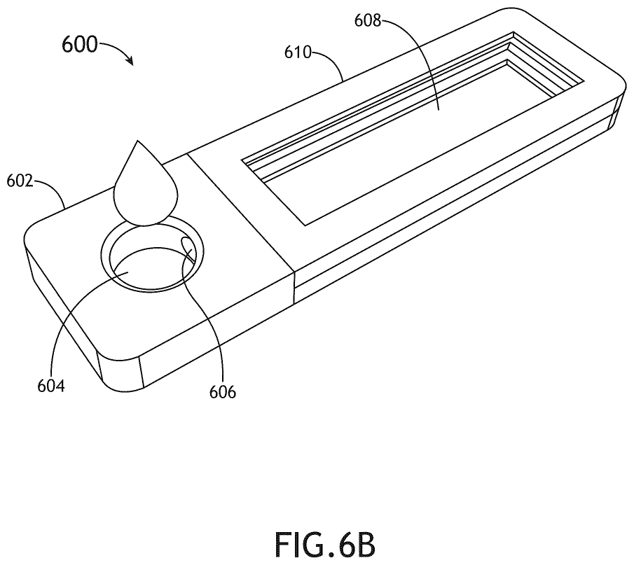

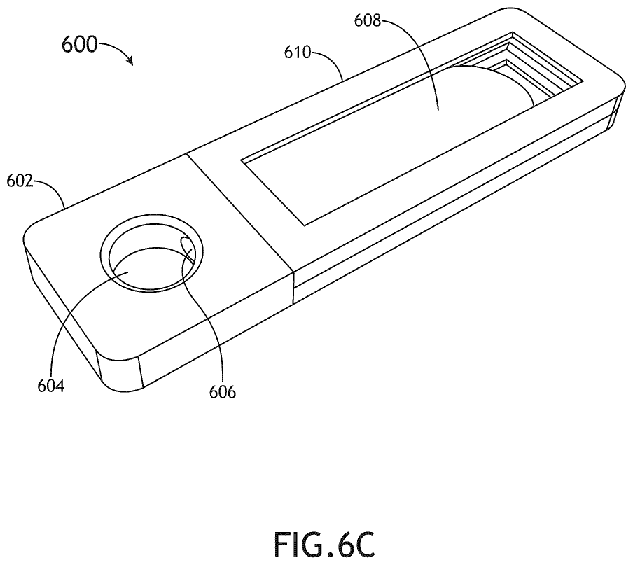

FIGS. 6A through 6C illustrate a rapid smear slide development system 600, in accordance with another embodiment of the present disclosure. The rapid smear slide development system 600 can also be used to produce smear slides from all types of fluid or semi-solid specimens, such as biological samples (e.g., blood, bone marrow, urine, saliva, etc.), environmental samples (e.g., water, sediment, wastewater, etc.), commercial fluid samples (e.g., pre-processed fluids, partially processed fluids, post-processed fluids, byproducts, etc.), and so forth, for the purpose of laboratory testing, field testing, data collection, or any other application.

Referring now to FIG. 6A, the rapid smear slide development system 600 includes a housing 602 for a sample reservoir 604. The housing 602 may be constructed from any appropriate material, such as an injection molded plastic, 3D printed plastic, or the like. The system 100 further includes a slide frame 610 connected to the sample reservoir 602 (i.e., connected to the sample reservoir housing 602), and two slides 608 fixed within the slide frame 610. As shown in FIGS. 6B and 6C, the sample reservoir 602 is configured to receive a specimen and direct the specimen in between the two slides 608 through a channel 606 that extends between the sample reservoir 604 and the two slides 608, thereby causing the specimen to spread between the two slides 608 to produce a smear pattern between the two slides 608 as a result of capillary action.

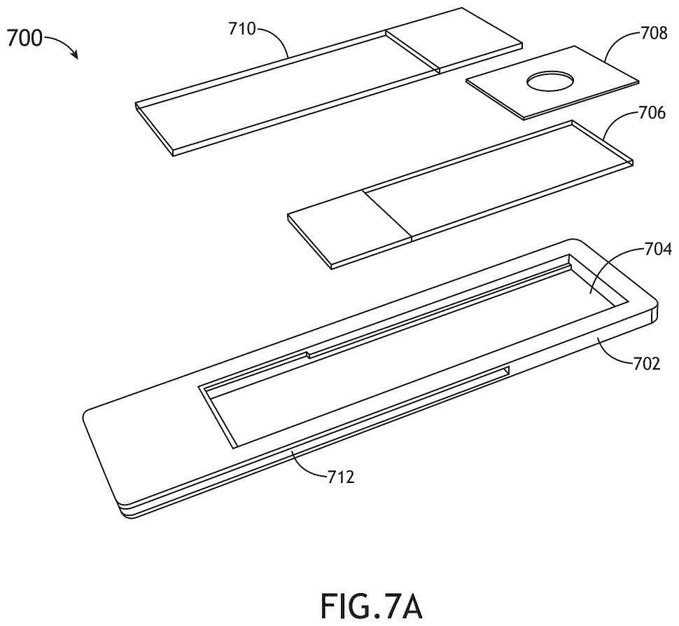

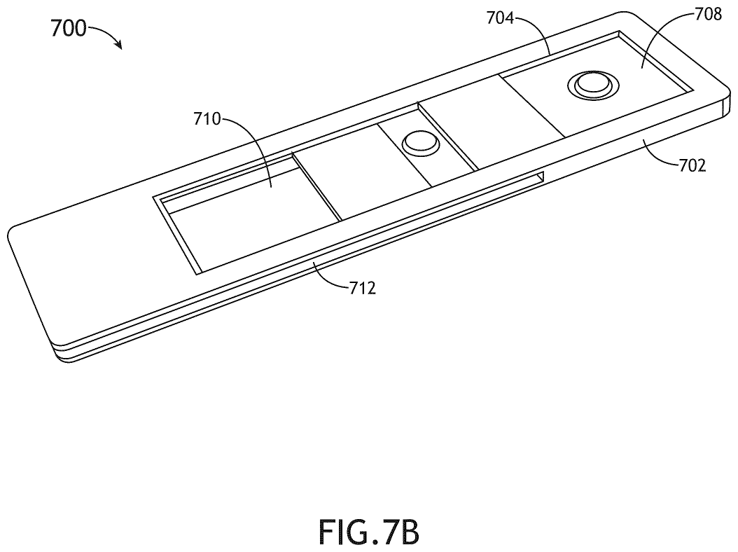

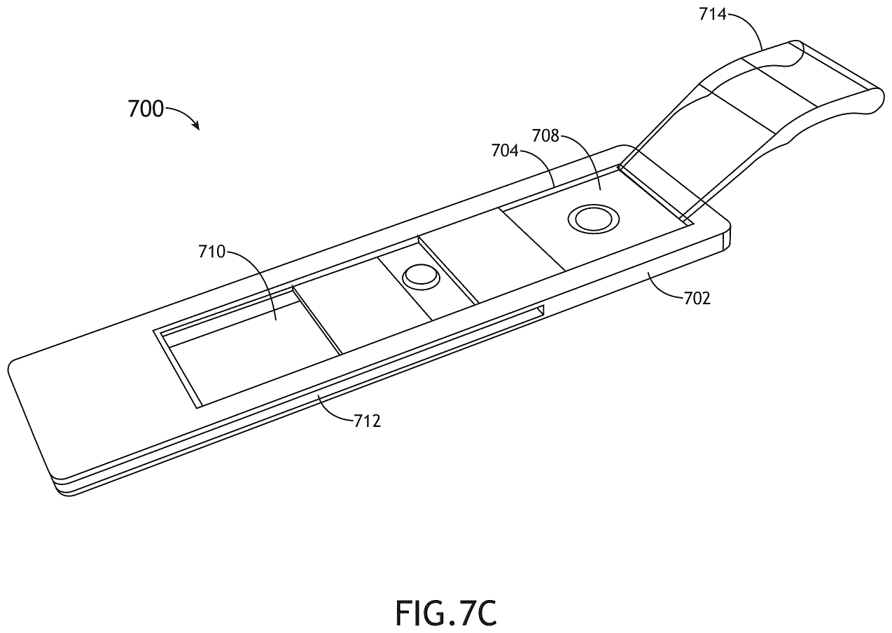

FIGS. 7A through 7D illustrate a rapid smear slide development system 700, in accordance with another embodiment of the present disclosure. The rapid smear slide development system 700 can also be used to produce smear slides from all types of fluid or semi-solid specimens, such as biological samples (e.g., blood, bone marrow, urine, saliva, etc.), environmental samples (e.g., water, sediment, wastewater, etc.), commercial fluid samples (e.g., pre-processed fluids, partially processed fluids, post-processed fluids, byproducts, etc.), and so forth, for the purpose of laboratory testing, field testing, data collection, or any other application.

The rapid smear slide development system 700 can be used to simultaneously produce a thick smear slide and a thin smear slide. As shown in FIG. 7A, the system 700 includes base member 702 including a slide dock 704 formed by an indented portion of the base member 702. The base member 702 may be constructed from any appropriate material, such as an injection molded plastic, 3D printed plastic, or the like. The base member 702 is configured to hold two overlapping slides (thick smear slide 706 and thin smear slide 710) offset by a thick smear stencil 708 within the slide dock 704.

As shown in FIG. 7B, specimen droplets can be applied to each of the two slides with one of the droplets being placed within the thick smear stencil 708 that is on top of the thick smear slide 706. A handheld scraper 714 or any other handheld smearing tool can be used to spread the specimen within the thick smear stencil 708 to produce a thick smear pattern on slide 706, as shown in FIG. 7C.

Referring now to FIG. 7D, the base member 702 has a guide rail 714 extending at least partially along at least one edge of the base member 702. In preferred embodiments, the base member 702 has guide rails 714 along both of its long edges. The system 700 further includes a wiper 716 configured to glide along the guide rail(s) 714, wherein the wiper 716 is configured to actuate a scraper 718 across the slide 710 so that the specimen on slide 710 is smeared across the slide 710 to produce a thin smear pattern on slide 710.

Although the scraper 718 in FIGS. 7A through 7D is shown as being removably coupled to the wiper 716, much like scraper 118 and wiper 116, the scraper 718 and wiper 716 structures can alternatively be similar to those (scraper 514 and wiper 512) described with reference to FIGS. 5A through 5C, and vice versa. In embodiments with a scraper built into the wiper, the scraper may have a flexible edge (e.g., like a windshield wiper) thereby allowing a user to control the scraping pressure applied to a slide based on how hard they push down on the wiper.

As previously noted, the embodiments illustrated in FIGS. 1A through 7D are specific examples that can be modified by changing dimensions or adding/removing non-essential components or fillers. Furthermore, two or more embodiments (or portions thereof) can be combined to achieve an additional embodiment that is not necessarily shown or described with reference to one drawing. As such, the drawings should not be construed as restrictive of any particular embodiment and are intended instead as visual aids to help describe configurations of certain components that may apply to multiple embodiments of a rapid smear slide development system.

Although the technology has been described with reference to the embodiments illustrated in the attached drawing figures, equivalents may be employed, and substitutions may be made herein without departing from the scope of the technology as recited in the claims. Components illustrated and described herein are examples of devices and components that may be used to implement the embodiments of the present invention and may be replaced with other devices and components without departing from the scope of the invention. Furthermore, any dimensions, degrees, and/or numerical ranges provided herein are to be understood as non-limiting examples unless otherwise specified in the claims.

What is claimed:

1. A rapid smear slide development system, comprising:
a base member;
a slide dock formed by an indented portion of the base member, wherein the base member is configured to hold a slide within the slide dock;
a guide rail extending at least partially along at least one edge of the base member; and
a wiper configured to glide along the guide rail, wherein the wiper is configured to actuate a scraper across a specimen on the slide so that the specimen is smeared across the slide, wherein the scraper is removable, wherein the wiper is configured to receive the scraper and hold the scraper at an angle with respect to the slide when the slide is held within the slide dock.

2. The rapid smear slide development system of claim 1, wherein the slide dock includes a cutout portion that extends through the base member to allow for dismounting the slide from the slide dock by reaching through the cutout portion.

3. The rapid smear slide development system of claim 1, wherein the slide dock includes a thin smear specimen location and size indicator.

4. The rapid smear slide development system of claim 3, wherein the thin smear specimen location and size indicator comprises a hole that extends through the base member.

5. The rapid smear slide development system of claim 1, wherein the slide dock includes a thick smear depth indicator.

6. The rapid smear slide development system of claim 5, wherein the thick smear depth indicator comprises a high contrast graphic.

7. The rapid smear slide development system of claim 3, wherein the base member includes a loading dock for the guide rail at one end of the base member and a guide rail stop at another end of the base member, wherein the guide rail stop positions the scraper at the thin smear specimen location and size indicator.

8. (canceled)

9. The rapid smear slide development system of claim 1, wherein the scraper is another slide.

10. The rapid smear slide development system of claim 1, wherein the scraper is built into the wiper, and wherein the scraper includes a flexible edge so that scraping pressure can be controlled based on how hard the wiper is pushed down.

11. The rapid smear slide development system of claim 1, further comprising one or more quick read (QR) codes on the base member and/or the slide, wherein the one or more QR codes are detectable by an analyzer that is configured to photograph and/or optically analyze the slide after the specimen has been smeared across the slide.

12. The rapid smear slide development system of claim 11, wherein the one or more QR codes are configured to relay information to the analyzer, including at least one of: specimen identifying information, specimen type, specimen preparation details, or microscopy details.

13. (canceled)

14. (canceled)

15. A method of preparing a thin smear slide, comprising:
placing a slide within a slide dock formed by an indented portion of a base member, wherein the base member includes a guide rail extending at least partially along at least one edge of the base member;
applying a specimen to the slide; inserting a scraper into a wiper;
positioning the scraper in the specimen, wherein positioning the scraper in the specimen causes the specimen to spread along a contact line between the scraper and the slide; and
actuating the scraper across the slide with a wiper that is configured to glide along the guide rail so that the specimen is smeared across the slide by the scraper.

16. The method of claim 15, wherein the slide dock includes a thin smear specimen location and size indicator.

17. The method of claim 16, wherein the thin smear specimen location and size indicator comprises a hole that extends through the base member.

18. (canceled)

19. A rapid smear slide development system, comprising:
a sample reservoir;
a slide frame connected to the sample reservoir; and
two slides fixed within the slide frame, wherein the sample reservoir is configured to receive a specimen and direct the specimen in between the two slides through a channel that extends between the sample reservoir and the two slides, thereby causing the specimen to spread between the two slides to produce a smear pattern between the two slides as a result of capillary action.

20. (canceled)

21. The rapid smear slide development system of claim 1, wherein the wiper is configured to place the scraper in contact with the slide.

22. The rapid smear slide development system of claim 1, wherein the wiper is configured to orient the scraper at an angle between 20 to 80 degrees relative to the slide.

23. The method of claim 15, wherein inserting the scraper into the wiper comprises inserting the scraper into the wiper at an angle between 20 to 80 degrees relative to the slide.
